(19) United States
(12) Patent Application Publication
(10) Pub. No.: US 2026/0088546 A1
(43) Pub. Date: Mar. 26, 2026

(54) PRESS FIT PIN AND METHOD OF ASSEMBLING A PRESS FIT PIN

(71) Applicant: NEXPERIA B.V., Nijmegen (NL)

(72) Inventors: Siu Lung Ng, Hong Kong (HK); Chenchao Zhong, Hong Kong (HK); Zhou Zhou, Hong Kong (HK)

(73) Assignee: NEXPERIA B.V., Nijmegen (NL)

(21) Appl. No.: 19/341,063

(22) Filed: Sep. 26, 2025

(30) Foreign Application Priority Data
Sep. 26, 2024 (NL) 2038723

(51) Int. Cl. H01R 13/17; H01R 12/70; H01R 12/71; H01R 13/24; H01R 43/20

(52) U.S. Cl. CPC H01R 13/17; H01R 12/7064; H01R 12/714; H01R 13/2421; H01R 43/20

(57) ABSTRACT

The present disclosure relates to the field of press fit pins as well as a method for manufacturing a press fit pin used in a semiconductor power modules. This disclosure proposes a novel structure of press fit pin that can provide a better mechanical and electrical connection between the module and a printed circuit board (PCB), by using a sheet spring with four leaves. Additionally, a roll spring used in the disclosure functions as stress buffer and direct based copper (DBC), warpage compensation.

### CROSS-REFERENCE TO RELATED APPLICATIONS

This application claims the benefit under 35 U.S.C. § 119(a) of Dutch Patent Application No. NL 2038723 filed Sep. 26, 2024, the contents of which are incorporated by reference herein in their entirety.

### BACKGROUND

### 1. Field of the Disclosure

The present disclosure relates to the field of press fit pins as well as a method for manufacturing a press fit pin used in a semiconductor power modules.

### 2. Description of the Related Art

Document U.S. Pat. No. 11,387,588B2 discloses a power semiconductor module with press-fit contact element. The press-fit contact element has a press-fit portion, a compensating portion and a foot portion, the compensating portion being elastic in a longitudinal direction of the press-fit contact element and having at least two O-shaped sub-portions arranged in succession in the longitudinal direction and having a constriction arranged between two sub-portions.

Document U.S. Pat. No. 10,855,009B2 provides a press-fit pin. The press-fit pin includes: a press unit press-fitted into a through hole formed on a board, which is press-fitted into an inner surface of the board including the through hole, pressurized toward a long hole formed inside the press unit, applies a repulsive force to the inner surface of the board through an elastic force, and maintains a contact with the inner surface of the board; a first terminal which is extended for a predetermined length from one side of the press unit along a longitudinal direction of the press unit and is disposed at the upper side of the board when press fitting the press unit; and a second terminal which is extended for a predetermined length from the other side of the press unit along the longitudinal direction of the press unit and is disposed at the lower side of the board, when press fitting the press unit, wherein the press unit includes a plurality of press-fit parts which faces each other along a width direction of the press unit based on the long hole, is pressurized to the inside along the width direction of the press unit and a thickness direction of the press unit, which crosses the width direction of the press unit, when the plurality of press-fit parts is press-fitted into the through hole, and applies a repulsive force toward the width direction of the press unit and the thickness direction of the press unit using an elastic force.

Prior art document WO2014042264A1 discloses connection terminal for power module capable of stably maintaining a good contact state. A connection terminal is a part of a power module provided with a semiconductor element, a substrate on which the semiconductor element is mounted, and a conductive retaining member joined to the surface of the substrate and made to form a cylinder shape extending in the direction perpendicular to the surface. It continuously electrically connects the substrate and an exterior circuit by being supported by the retaining member and is being formed by wrapping a conductive wire, the connection terminal being provided with: an insertion part inserted into the hollow section of the retaining member, at least part of which is tightly wound; a rough winding part on which wire is wrapped at a prescribed interval; and a contact section for contacting the exterior circuit, the contact section provided to the end section of the rough winding part on a different side than the end section on the insertion part side, and the insertion part having a press-fit section having a diameter larger than that of the hollow section.

### SUMMARY

Press fit pins are a key components of a semiconductor power module. This disclosure proposes a novel structure of press fit pin that can provide a better mechanical and electrical connection between the module and a printed circuit board, PCB, by using sheet spring with four leaves. Additionally, a roll spring used in disclosure functions as stress buffer and direct based copper, DBC, warpage compensation.

According to the first example of the disclosure, a press fit pin is disclosed, which comprises a sheet spring, a roll spring, a metal pillar, and a base. The base comprises a bottom part and a cylinder part. The cylinder part on one side is connected to the bottom part and on the other side comprises a closing means. The bottom part, the cylinder part and a flange are forming a blind hole. The metal pillar comprises a top metal pillar part, a bottom metal pillar part, a first rim located at the outer end of the top metal pillar part, and a second rim located between the top metal pillar part and the bottom metal pillar part. The bottom metal pillar part is connected to the first rim with a connecting portion having smaller diameter than the bottom metal pillar part. The sheet spring is surrounding the top metal pillar part and is placed between the first rim and the second rim. The roll spring that serves as a stress buffer rests on the bottom part of the base and on the outer end of the bottom metal pillar part. The bottom metal pillar part is inserted into the base such that the flange is surrounding the connecting portion in a movable manner and wherein a diameter of the blind hole in a section defined by the flange is smaller than a diameter of the bottom metal pillar part and the second rim.

Preferably the sheet spring comprises preferably four leaves designed to be inserted into a plated through hole in the printed circuit board. Such solution provides a better connection between the press fit pin and the printed circuit board.

Preferably the flange comprises at least one notch. This will allow to prepare the flange prior to the assembly and it will make it easier to assembly since the metal pillar may be simply pressed into the base.

According to the second example of the disclosure, a method of assembling a press fit pin is disclosed. The method comprises the following steps: step a-placing a sheet spring on the first end of the press fit pin in the top metal pillar part between the first rim and the second rim, step b-placing a roll spring into a blind hole, step c-placing a pillar into the blind hole such that the roll spring is between a bottom metal pillar part and a bottom part and a flange is surrounding the connecting portion in a movable manner.

Preferably the flange with at least one notch is formed prior to step c. Such approach will make a manufacturing devices less complex.

Preferably the flange is formed after the pillar is placed into the blind hole in step c. Such step provides a more flexible approach to assembly since it may be beneficial to prepare a flange, in an especially thin metal pillars, so that the metal pillar will not bend while being pushed into premade flange.

Preferably step a occurs after step c. Such step provides a more flexible approach to assembly.

Preferably prior to step a), additional steps are performed, namely steps of: step d—taking a flat metal sheet, step e—adding cutouts in the metal sheet and forming leaves, step f—pressing the sheet metal leaves so that they bend, step g—rolling the metal sheet in order to form a hollow metal tube.

### BRIEF DESCRIPTION OF THE DRAWINGS

The disclosure will now be discussed with reference to the drawings, which:

FIG. 1 main components of the press fit pin.

FIG. 2 a cross section of the press fit pin.

FIG. 3 main components of the disassembled press fit pin.

FIG. 4 depicting the method steps for manufacturing a sheet spring.

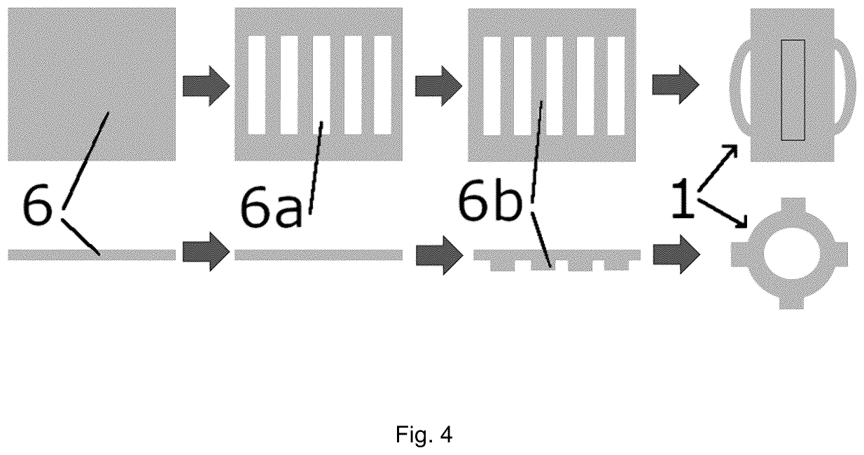

### DETAILED DESCRIPTION

For a proper understanding of the disclosure, in the detailed description below corresponding elements or parts of the disclosure will be denoted with identical reference numerals in the drawings.

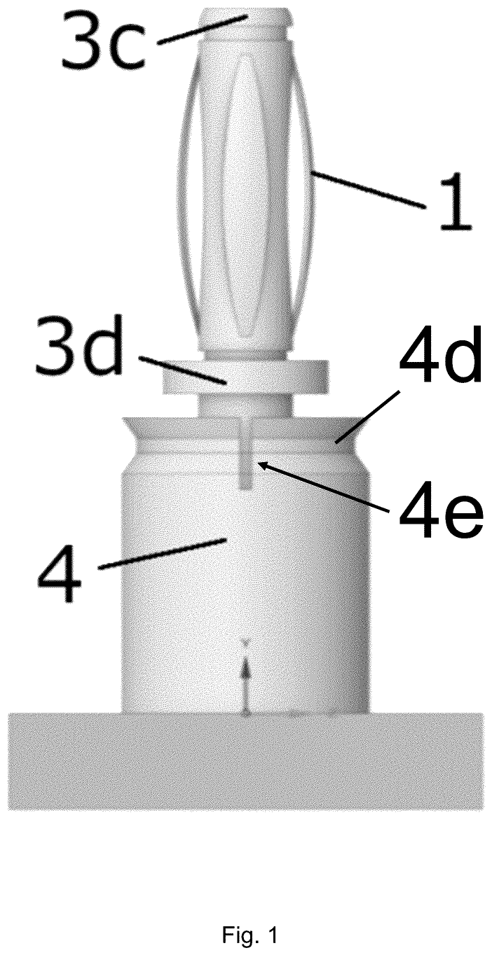

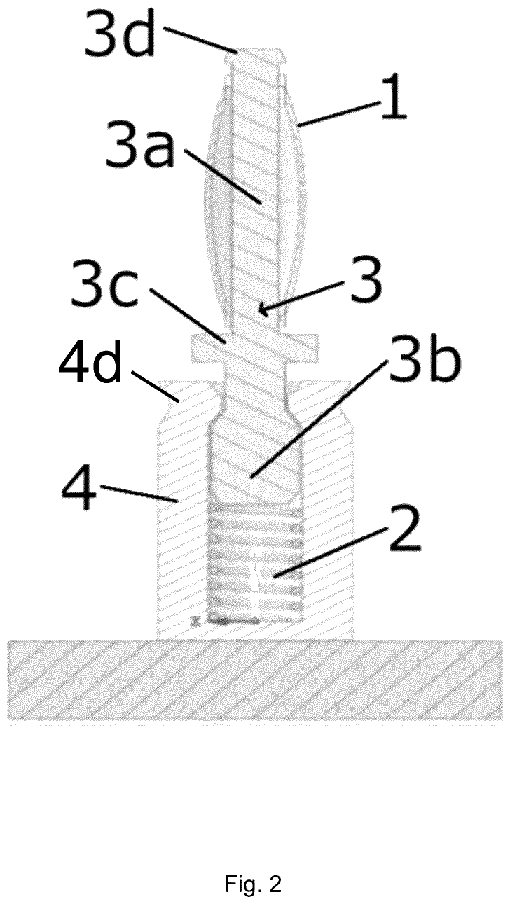

FIGS. 1 and 2 show main components of the press fit pin. The press fit pin comprises a sheet spring 1, a roll spring 2, a metal pillar 3, and a base 4. The base 4 comprises a bottom part 4a and a cylinder part 4b, wherein the cylinder part 4b on one side is connected to the bottom part 4a and on the other side comprises a flange 4d. The bottom part 4a, the cylinder part 4b and the flange 4d are forming a blind hole 4c. The bottom part 4a serves as a base for establishing electrical contact with the mounting section of a direct based copper, DBC, substrate using solder, conductive adhesive, similar conductive materials, or laser welding.

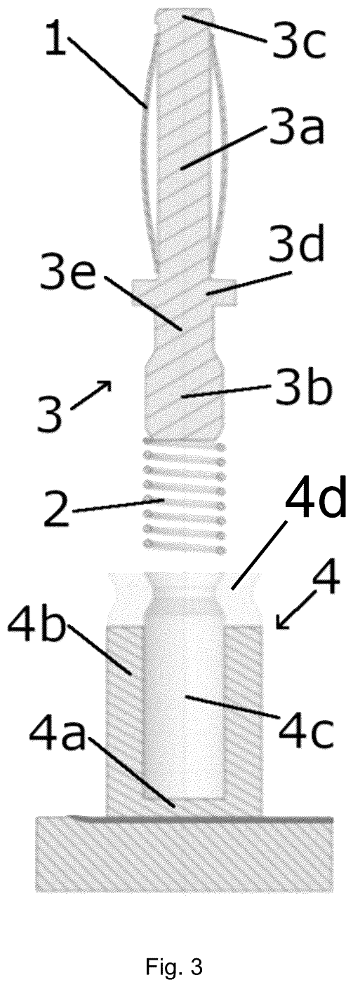

FIG. 3 shows main components of the disassembled press fit pin, especially parts of the metal pillar 3. The metal pillar 3 comprises a top metal pillar part 3a, a bottom metal pillar part 3b, a first rim 3c located at the outer end of the top metal pillar part 3a, and a second rim 3d located between the top metal pillar part 3a and the bottom metal pillar part 3b. In this example the bottom metal pillar part 3b is connected to the first rim 3c with a connecting portion 3e having smaller diameter than the bottom metal pillar part 3b, which makes the connecting portion 3e movable after inserting the metal pillar part 3b into the flange 4d of the base 4. It should be noted that the flange 4d may have at least one notch 4e which will allow an easier manufacture of the press fit since the flange 4d may be, in this case, made prior to inserting the metal pillar 3.

The sheet spring 1 is surrounding the top metal pillar part 3a and is placed between the first rim 3c and the second rim 3d.

The roll spring 2 that serves as a stress buffer rests on the bottom part 4a of the base 4 and on the outer end of the bottom metal pillar part 3b. The roll spring 2 provides a degree of elasticity or flexibility in order to compensate for forces arising due to external influences such as thermal expansion, dimensional tolerance, mounting tolerance and/or DCB warpage. This compensating portion prevents excessively large forces from acting on the electrical connection established by the press fit pin. During the module mount or dis-mount into the PCB, the stress created from the movement will be absorbed by the roll spring 2 to prevent damage to the DBC substrate.

The bottom metal pillar part 3b is inserted into the base 4 such that the flange 4d is surrounding the connecting portion 3e in a movable manner.

In this example, the sheet spring 1 comprises four leaves 6b designed to be inserted into a plated through hole in the printed circuit board. However, it should be noted that different number of leaves 6b also can be used. When the press-fit pins push into the PCB holes, the sheet spring leaves 6b will deform and push against the side wall of the holes which create a better and stable mechanical and electrical connection between a module and a printed circuit board, PCB.

A method of assembling a press fit pin according to the disclosure is also disclosed. A first step, step a, is placing a sheet spring 1 on the first end of the press fit pin in the top metal pillar part 3a between the first rim 3c and the second rim 3d. In a next step, step b, a roll spring 2 is placed into a blind hole 4c. In the next step, step c, a pillar 3 is placed into the blind hole 4c such that the roll spring 2 is between a bottom metal pillar part 3b and a bottom part 4a and a flange 4d is surrounding the connecting portion 3e in a movable manner. It should be noted that step a may, in another embodiment, be performed after step c.

In one embodiment the flange 4d with at least one notch 4e is formed prior to step c. In another embodiment the flange 4d is formed after the pillar 3 is placed into the blind hole 4c in step c.

In yet another embodiment prior to step a, additional steps are performed to form the sheet spring 1. First of this step, step d, is to take a flat metal sheet 6, and next, during step e, cutouts 6a are added in the metal sheet 6 and forming leaves 6b. Next, in step f, the sheet metal leaves 6b are pressed so that they bend, and finally, in step g, the metal sheet 6 is rolled in order to form a hollow metal tube and to form the sheet spring 1.

### LIST OF REFERENCE NUMERALS USED

1 sheet spring
2 roll spring
3 metal pillar
3a top metal pillar part
3b bottom metal pillar part
3c first rim
3d second rim
3e connecting portion
4 base
4a bottom part
4b cylinder part
4c blind hole
4d flange
4e notch
6 metal sheet
6a metal sheet cutouts
6b metal sheet leaf

1. A press fit pin comprising:
a sheet spring,
a roll spring,
a metal pillar,
a base,
wherein the base comprises a bottom part and a cylinder part, wherein the cylinder part on one side is connected to the bottom part and on the other side comprises a closing means, wherein the bottom part, the cylinder part and a flange are forming a blind hole,
wherein the metal pillar comprises a top metal pillar part, a bottom metal pillar part, a first rim located at the outer end of the top metal pillar part, and a second rim located between the top metal pillar part and the bottom metal pillar part, and wherein the bottom metal pillar part is connected to the first rim with a connecting portion having smaller diameter than the bottom metal pillar part,
wherein the sheet spring is surrounding the top metal pillar part and is placed between the first rim and the second rim,
wherein the roll spring that serves as a stress buffer rests on the bottom part of the base and on the outer end of the bottom metal pillar part,
wherein the bottom metal pillar part is inserted into the base so that the flange is surrounding the connecting portion in a movable manner and a diameter of the blind hole in a section defined by the flange is smaller than a diameter of the bottom metal pillar part and the second rim.

2. The press fit pin according to claim 1, wherein the sheet spring comprises four leaves designed to be inserted into a plated through hole in the printed circuit board.

3. The press fit pin according to claim 1, wherein the flange comprises at least one notch.

4. A method of assembling a press fit pin according to claim 1, comprising the steps of:
a) placing a sheet spring on the first end of the press fit pin in the top metal pillar part between the first rim and the second rim,
b) placing a roll spring into a blind hole, and
c) placing a pillar into the blind hole so that the roll spring is between a bottom metal pillar part and a bottom part and a flange is surrounding the connecting portion in a movable manner.

5. The method of assembling a press fit pin according to claim 4, wherein the flange with at least one notch is formed prior to step c).

6. The method of assembling a press fit pin according to claim 4, wherein the flange is formed after the pillar is placed into the blind hole in step c).

7. The method of assembling a press fit pin according to claim 4, wherein step a) occurs after step c).

8. The method of assembling a press fit pin according to claim 4, wherein prior to step a) additional steps are performed, namely the steps of:
d) taking a flat metal sheet,
e) adding cutouts in the metal sheet and forming leaves,
f) pressing the sheet metal leaves so that they bend, and
g) rolling the metal sheet in order to form a hollow metal tube.

9. The press fit pin according to claim 2, wherein the flange comprises at least one notch.

10. A method of assembling a press fit pin according to claim 2, comprising the steps of:
a) placing a sheet spring on the first end of the press fit pin in the top metal pillar part between the first rim and the second rim,
b) placing a roll spring into a blind hole, and
c) placing a pillar into the blind hole so that the roll spring is between a bottom metal pillar part and a bottom part and a flange is surrounding the connecting portion in a movable manner.

11. A method of assembling a press fit pin according to claim 3, comprising the steps of:
a) placing a sheet spring on the first end of the press fit pin in the top metal pillar part between the first rim and the second rim,
b) placing a roll spring into a blind hole, and
c) placing a pillar into the blind hole so that the roll spring is between a bottom metal pillar part and a bottom part and a flange is surrounding the connecting portion in a movable manner.

12. The method of assembling a press fit pin according to claim 5, wherein step a) occurs after step c).

13. The method of assembling a press fit pin according to claim 5, wherein prior to step a) additional steps are performed, namely the steps of:
d) taking a flat metal sheet,
e) adding cutouts in the metal sheet and forming leaves,
f) pressing the sheet metal leaves so that they bend, and
g) rolling the metal sheet in order to form a hollow metal tube.

14. The method of assembling a press fit pin according to claim 6, wherein step a) occurs after step c).

15. The method of assembling a press fit pin according to claim 6, wherein prior to step a) additional steps are performed, namely the steps of:
d) taking a flat metal sheet,
e) adding cutouts in the metal sheet and forming leaves,
f) pressing the sheet metal leaves so that they bend, and
g) rolling the metal sheet in order to form a hollow metal tube.
